(19) United States
(12) Patent Application Publication
(10) Pub. No.: US 2015/0242112 A1
(43) Pub. Date: Aug. 27, 2015

(54) HUMAN INTERFACE DEVICE WITH TOUCH SENSOR

(71) Applicant: Microsoft Corporation, Redmond, WA (US)

(72) Inventors: George Bielitz, Sammamish, WA (US); John Howard Cook, III, Fort Collins, CO (US); Bradley Robert Martin, Auburn, WA (US)

(73) Assignee: Microsoft Corporation, Redmond, WA (US)

(21) Appl. No.: 14/190,707

(22) Filed: Feb. 26, 2014

(51) Int. Cl. G06F 3/0488; G06F 3/0354; G06F 3/038; G06F 3/044

(52) U.S. Cl. CPC G06F 3/04883; G06F 3/044; G06F 3/03543; G06F 3/0383; G06F 2203/04808; G06F 2203/0381; G06F 2203/0336

(57) ABSTRACT

Embodiments are disclosed that relate to human interface devices having touch sensors. For example, one disclosed embodiment provides a human interface device including a touch sensor comprising two or more touch sensing units, each touch sensing unit comprising a touch sensing pad and a charge accumulation capacitor in communication with the touch sensing pad, the charge accumulation capacitor having a larger capacitance than the touch sensing pad. The human interface device further includes a controller in communication with each touch sensing unit, the controller being configured to acquire a touch sensing sample from each touch sensing unit by iteratively charging the touch sensing pad of the touch sensing unit and transferring charge from the touch sensing pad of the touch sensing unit to the charge accumulation capacitor of the touch sensing unit until a threshold has been met, and detect a touch gesture based upon the touch sensing samples.

### BACKGROUND

Human interface devices, such as computer mice, keyboards, keypads, and the like, may provide multiple mechanisms for navigating a computer user interface. For example, a computer mouse having optical tracking and selection buttons to interact with a cursor on a user interface also may include a scroll wheel that allows a user to scroll displayed content independent of cursor motion. Some mice also may include a built-in touch sensor configured to allow a user to perform touch interactions via the mouse. Such touch-sensors may have a structure similar to a touch sensor on a display, in that the touch sensor comprises a matrix of row and column sensing elements. Touch may be sensed by measuring capacitance from each row to each column, or from each column to ground and each row to ground.

### SUMMARY

Embodiments are disclosed that relate to human interface devices having touch sensors. For example, one disclosed embodiment provides a human interface device comprising a touch sensor having two or more touch sensing units, each touch sensing unit comprising a touch sensing pad and a charge accumulation capacitor in communication with the touch sensing pad. The charge accumulation capacitor may have a larger capacitance than the capacitance between the touch sensing pad and electrical ground when a human finger or thumb is proximate to the touch sensing pad. The human interface device further comprises a controller in communication with each touch sensing unit, the controller being configured to acquire a touch sensing sample from each touch sensing unit by iteratively charging the touch sensing pad of the touch sensing unit and transferring charge from the touch sensing pad of the touch sensing unit to the charge accumulation capacitor of the touch sensing unit until a threshold has been met, and detect a touch gesture based upon the touch sensing samples.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an embodiment of a human interface device in the form of a computer mouse having a touch sensor.

FIG. 2 shows an embodiment of a touch sensor suitable for use with the human interface device of FIG. 1.

FIG. 3 shows an electrical schematic diagram for the touch sensor of FIG. 2.

FIG. 4 shows a schematic depiction of example touch sensor interactions and also of example touch sensor outputs in response to the interactions.

FIG. 5 shows a graphical depiction of an output of two touch sensing units during a swipe up interaction with an embodiment of a touch sensor.

FIG. 6 shows a graphical depiction of an output of two touch sensing units during a swipe down interaction with an embodiment of a touch sensor.

FIG. 7 shows a graphical depiction of swipe touch input parameters according to an embodiment.

FIG. 8 shows a graphical depiction of an output of two touch sensing units during a tap interaction and also tap input parameters according to an embodiment.

FIG. 9 shows a flow diagram depicting an embodiment of a method for operating a human interface device.

FIG. 10 shows an embodiment of a computing device.

### DETAILED DESCRIPTION

Various human interface devices, such as computer mice, keyboards, touch-sensitive displays and the like, may comprise a touch sensor to enable a user to interact with a computing device via a touch sensitive surface. Current touch sensors on computer mice may utilize an array of rows and column sensing elements that are read by measuring a capacitance between each row and each column, or between each row/column and ground. However, such touch sensors may be subject to noise from other human interface device components. As the capacitances between the rows and columns may be relatively small, such noise may lead to problems in touch sensing. Additionally, such sensors may be unduly expensive and complex if it is desired to detect a relatively small number of specific gestures.

Thus, embodiments are disclosed herein that relate to touch sensors for human interface devices. Briefly, the disclosed touch sensors utilize a the capacitance between a touch sensing pad and electrical ground, in connection with a and charge accumulation capacitor, for each of a plurality of touch sensing units to sense touch. Further, rather than being formed from a matrix of horizontal and vertical conductors, the disclosed embodiments of touch sensors utilize a relatively smaller number of larger area touch sensing pads arranged, for example, along a path of a gesture to be detected via the sensor. A touch sensing capacitor may be formed based on the self-capacitance that exists between a touch sensing pad that may be, for example, located on a computer mouse, and electrical ground. The self-capacitance is altered by the proximity of a human finger or thumb to the touch sensing pad. Herein, the capacitor that is formed by the touch sensing pad and surfaces connected to electrical ground, and influenced by objects located between the touch sensing pad and electrical ground, if any, may be referred to as a touch sensing capacitor. Alternative touch sensors may rely on mutual capacitance, projected capacitance, or surface capacitance.

To sample a touch sensing unit, the capacitance between the touch sensing pad of the touch sensing unit and electrical ground is charged and then discharged onto the charge accumulation capacitor a plurality of times during each sample cycle. As a capacitance of the touch sensing capacitor increases when a finger is positioned over the touch sensing capacitor, more charge may be transferred to the charge accumulation capacitor during each charge/discharge cycle when touched than when not touched. Thus, a measure of the capacitance of the touch sensing capacitor may be determined from the sampling process. In one non-limiting example, the iterative charging and discharging of the touch sensing capacitor may be performed until a threshold voltage across the charge accumulation capacitor is reached. In such embodiments, a number of charge/discharge cycles used to reach the threshold voltage may represent the capacitance of the touch sensing capacitor, such that a smaller number of charge/discharge cycles represents a larger capacitance. In other embodiments, a selected threshold number of charge/discharge cycles may be performed, and then a time for the charge accumulation capacitor to drain may be determined as a measure of the capacitance of the touch sensing capacitor. It will be understood that these examples are intended to be illustrative, and not limiting.

The iterative charging of the touch sensitive capacitor and discharging onto the charge accumulation capacitor, combined with the relatively larger size of touch sensing capacitors relative to those of column/row matrix touch sensors, may help to provide a higher signal to noise ratio than row/column type touch sensors, in which a single measurement of each relatively smaller sensing element is taken per scan. Further, information about the change in the capacitance of each touch sensing capacitor over time may be used to detect touch gestures, as described below.

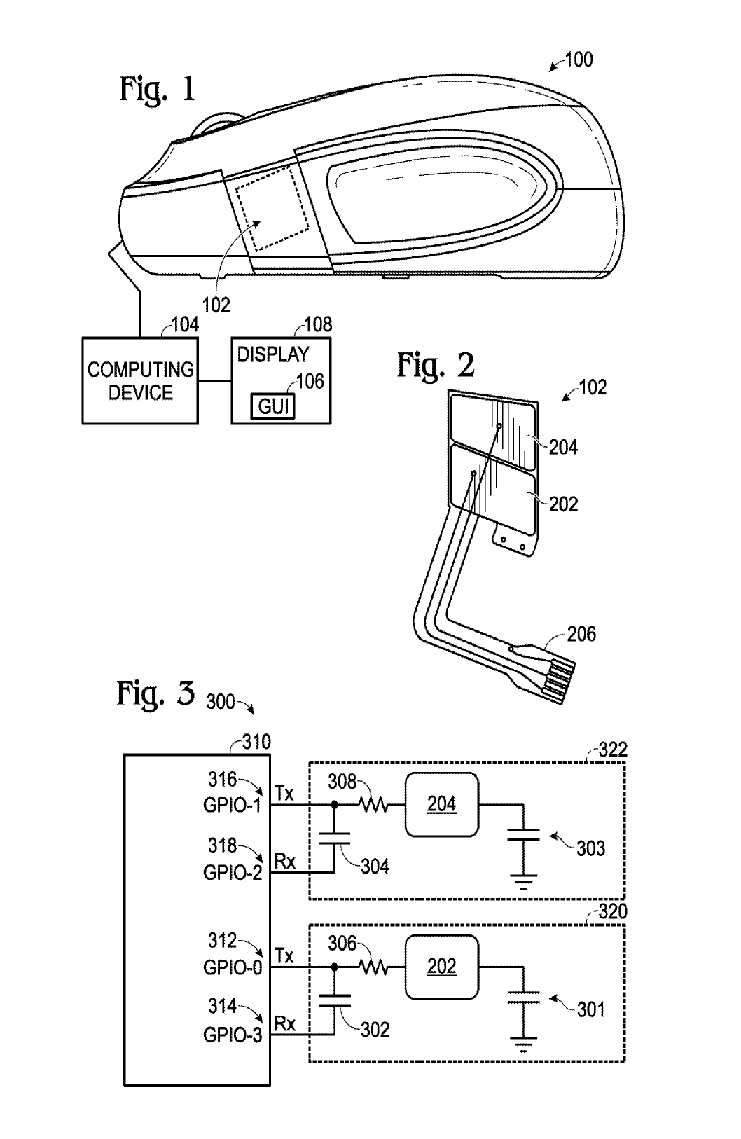

FIG. 1 shows an example embodiment of a human interface device in the form of a computer mouse 100 comprising a touch sensor 102 disposed on a thumb-side portion of a body of the computer mouse 100. The touch sensor 102 is shown as being located on a side of the mouse configured to be touched by a user's right thumb, but a touch sensor also may be configured to be touched via a user's left thumb. Further, in some embodiments, touch sensors may be located on both sides of the mouse 100. The computer mouse 100 is shown as being communicatively coupled (e.g. by wireless or wired link) to a host computing device 104. The computer mouse 100 thus may control a graphical user interface 106 output via a display 108 by host computing device 104.

As described in more detail below, the touch sensor 102 may be configured to detect a relatively small number of specific touch interactions, such as a thumb swipe gesture and/or a thumb tap gesture. As such, the touch sensor 102 may comprise a relatively low number of separate touch sensing elements arranged in a manner configured to allow detection of those gestures. FIG. 2 depicts an embodiment of sensor 102 that illustrates two touch sensing capacitors, shown as a first touch sensing capacitor 202 and a second touch sensing capacitor 204. Each touch sensing capacitor is in electrical communication with a contact pad 206 configured to couple to a controller. The two touch sensing capacitors are arranged along a direction of a thumb swipe gesture, such that a user performing a swipe-up or a swipe-down gesture will respectively swipe in different directions across the first and second touch sensing capacitors. Further, the depicted arrangement of touch sensing capacitors also may be used to detect a thumb tap gesture. It will be understood that these specific gestures are presented for the purpose of example, and are not intended to be limiting in any manner. Likewise, it will be understood that any suitable number of touch sensing capacitors may be arranged in any other suitable arrangement than that shown, depending upon a particular human interface device used and/or a gesture or gestures to be detected.

A touch sensor configured to detect specific gestures may be utilized, for example, where the specific gestures are mapped to specific operating system and/or application interactions. For example, some computing device operating systems may maintain menus and other user interface controls hidden during ordinary computing device use, but reveal these user interface controls upon performance of a specific touch gesture. As a more specific example, an operating system adapted for use with a touch sensitive display may be configured to reveal a menu bar, either vertically oriented at a side of the display or horizontally oriented at a bottom or top of a display, when a user performs a touch gesture (e.g. a tap or swipe gesture) on the touch sensitive display. Thus, gestures detectable by the touch sensor 102, such as a thumb swipe or tap, may be mapped to outputs configured to perform such interactions. As one non-limiting example, a thumb swipe gesture may be mapped to an output that is recognized by a host computing device as representing a keyboard input configured to reveal a hidden menu bar.

FIG. 3 illustrates an example sensing circuit 300 suitable for use with the touch sensor 102. The first touch sensing capacitor 202 and the second touch sensing capacitor 204 are each connected to ground on one side due to the self-capacitance of touch sensing capacitors 202 and 204. Capacitance due to a user touch is shown respectively as, and is modeled by, capacitors 301 and 303 for the first and second touch sensing capacitors. On the other side, each touch sensing capacitor is connected to a charge accumulation capacitor, shown respectively as first charge accumulation capacitor 302 and second charge accumulation capacitor 304 for the first and second touch sensing capacitors. A first resistor 306 is positioned between the first touch sensing capacitor 202 and the first charge accumulation capacitor 302, and a second resistor 308 is positioned between the second touch sensing capacitor 204 and the second charge accumulation capacitor 304. The charge accumulation capacitors 302, 304 each comprises a larger capacitance than the touch sensing capacitors 202, 204, such that the charge accumulation capacitors may hold charge transferred from multiple charge/discharge cycles of the touch sensing capacitors.

The charge accumulation capacitors are each connected to a corresponding first pin and second pin of a controller 310. In the depicted embodiment, the first charge accumulation capacitor 302 is shown as being connected to a first general purpose input/output (GPIO) pin 312 and a second GPIO pin 314, and the second charge accumulation capacitor 304 is shown as being connected to a third GPIO pin 316 and a fourth GPIO pin 318. Each corresponding touch sensing capacitor, resistor, and charge accumulation capacitor may be referred to herein as a touch sensing unit, wherein a first touch sensing unit is depicted at 320 and a second touch sensing unit is depicted at 322.

When a finger is close to or in contact with a touch sensing capacitor, the capacitance of the touch sensing capacitor increases. Thus, it takes fewer charge/discharge samples to reach a threshold amount of charge on the charge accumulation capacitor. By counting the number of charge/discharge cycles taken to reach the threshold, a touch state of each touch sensing capacitor may be determined.

The touch sensing units 320, 322 may be operated in any suitable manner One non-limiting method is as follows. While described in the context of the first touch sensing unit 320, it will be understood that the second touch sensing unit 322 may be operated in a similar manner.

First, the controller 310 may set the first GPIO pin 312 and the second GPIO pin 314 to ground to discharge the touch sensing circuit, and set a counter to zero to initialize a sampling process. Next, the first GPIO pin 312 is set to logic HIGH (e.g., a binary “1” value, which may be represented by 5V, 3.3V, 1.8V, etc.), and the second GPIO pin 314 is set to HIGH-Z (high impedance) to charge the first touch sensing capacitor 202. As mentioned above, the touch sensing capacitor may hold more charge when in a touched state than when in an untouched state. Next, the first GPIO pin 312 is set to HIGH-Z and the second GPIO pin 314 is set to LOW (e.g., a binary “0” value, which may be represented by 0V) to transfer charge from the first touch sensing capacitor 302 to the first charge accumulation capacitor 302. The counter is then incremented to reflect a number of charge/discharge cycles that have been performed. To determine whether the threshold has been met, the first GPIO pin 312 may be set to LOW and the second GPIO pin 314 may be set to an input and sampled to see if the logic threshold of the input has been crossed. If the logic threshold has not been crossed, then the first GPIO pin 312 is again set to high and the second GPIO pin 314 is set to HIGH-Z to again charge the first touch sensing capacitor 202 for another charge/discharge cycle. These steps may be repeated until the logic threshold of the second GPIO pin 314 in the input mode is met. Once the logic threshold is met, the current value of the counter is recorded as a measure of capacitance. The values obtained from each touch sensing unit may then be analyzed to detect the occurrence of any recognized touch gestures.

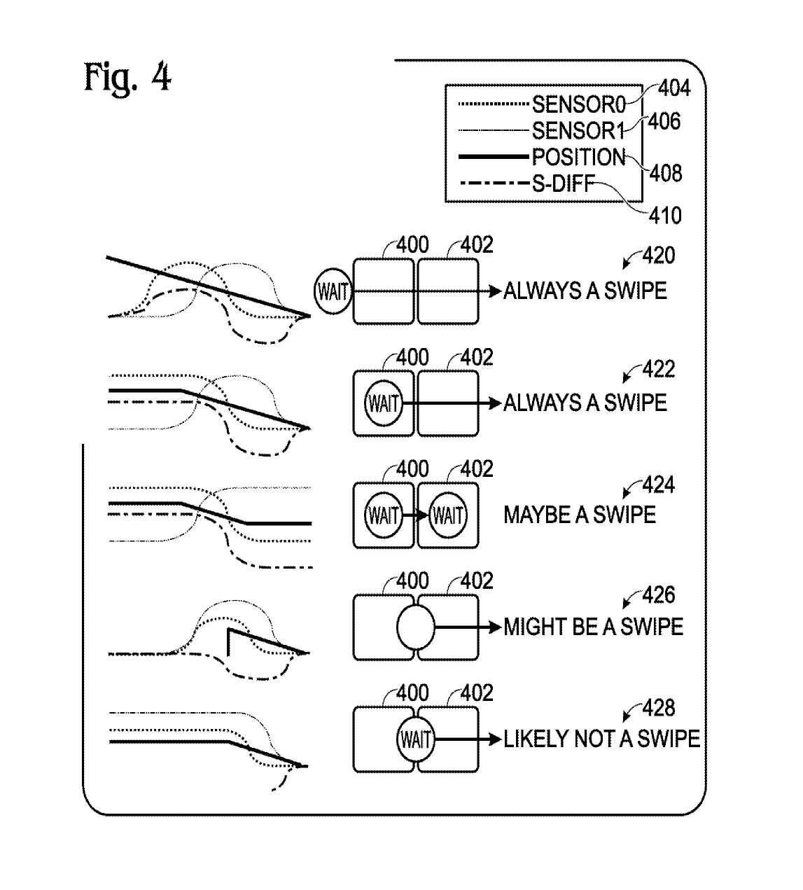

FIG. 4 shows a schematic depiction of various touch interactions with two touch sensor capacitors, shown as sensor0 400 and sensor1 402, and associated touch sensor data for the touch interactions. Sensor0 may correspond, for example, to the first touch sensing capacitor 202, and sensor1 may correspond, for example to the second touch sensing capacitor 204.

The touch sensor data includes output 404 of a first touch sensor (sensor0), output 406 of a second touch sensor (sensor1), finger position 408 as a function of time along a horizontal path through the two sensors as measured from a left edge of sensor0 to a right edge of sensor1, and a difference 410 between the first and second sensor outputs.

FIG. 4 also illustrates examples of methods for determining an occurrence of a swipe gesture with outputs sensor0 and sensor1. Each of the depicted touch interactions may have some characteristics of a swipe, in that a finger touches both sensor0 and sensor 1. However, in some instances, a user may touch both sensors and yet not intend to perform a swipe gesture. Thus, various rules may be applied to distinguish sensor outputs more likely to represent an intended swipe gesture from sensor outputs less likely to represent an intended swipe gesture. It will be understood that such rules may be determined in any suitable manner, including but not limited to use studies, and that different rules may be applied to different gesture types, different sensor configurations, computing device interactions to which gestures are mapped (e.g. based upon the user experience consequences for a false positive compared to a false negative), etc.

In the depicted example, relative confidences of each of the examples may depend upon such factors as starting location, ending location, starting condition (e.g. wait or no wait before movement across sensors), and ending condition (e.g. pause on sensor after movement or no pause). These confidences may be based, for example, upon a likelihood that a user will perform an intended touch gesture in a deliberate manner. For example, referring to the top two example gestures 420 and 422, where a touch starts from beyond a left edge of sensor0 or within sensor0, and travels all the way past the right edge of sensor1, a likelihood that a user intended to perform a swipe gesture may be relatively high. Next referring to the third example gesture 424 from the top, where a user stops and pauses over sensor1, it may be somewhat less likely, but still relatively likely, that the user intended to perform a swipe gesture. Continuing, the fourth gesture 426 from the top may potentially be less likely to be a swipe gesture, as the gesture starts in an ambivalent location that is over a border between sensor0 and sensor1. Next, the bottommost gesture 428 may have an even lower likelihood of being a swipe, as the touch position is held in an ambivalent location before movement.

Any suitable rules may be applied to determine whether or not a detected sensor interaction is a gesture input. As one non-limiting example, it may be determined that a swipe occurred if the following conditions are met: (a) the samples from the touch sensing units have a crossover point; (b) the touch goes from one touch sensing capacitor to another, and not back; and (c) the touch interacted with each sensor for a threshold time. Further, a rate of change between a touched and not touched state (or vice versa) for each sensor may be considered, wherein rapid changes may be considered more likely to represent a gesture. Additionally, in some embodiments, gestures may be sensed only after all sensors are untouched for a period of time. It will be understood that these rules for determining swipes are presented for the purpose of example, and are not intended to be limiting in any manner.

Rules may be used in any suitable manner to determine whether and how to provide outputs of detected gestures. For example, in some embodiments, rules may be used to determine a confidence value that is provided along with information regarding the touch gesture detected. This may allow an application (e.g. a computer program being executed on a computing device that receives the sensor output) to decide whether, and how, to use the output. Likewise, rules also may be used to determine whether or not to provide an output of a detected instance of the gesture.

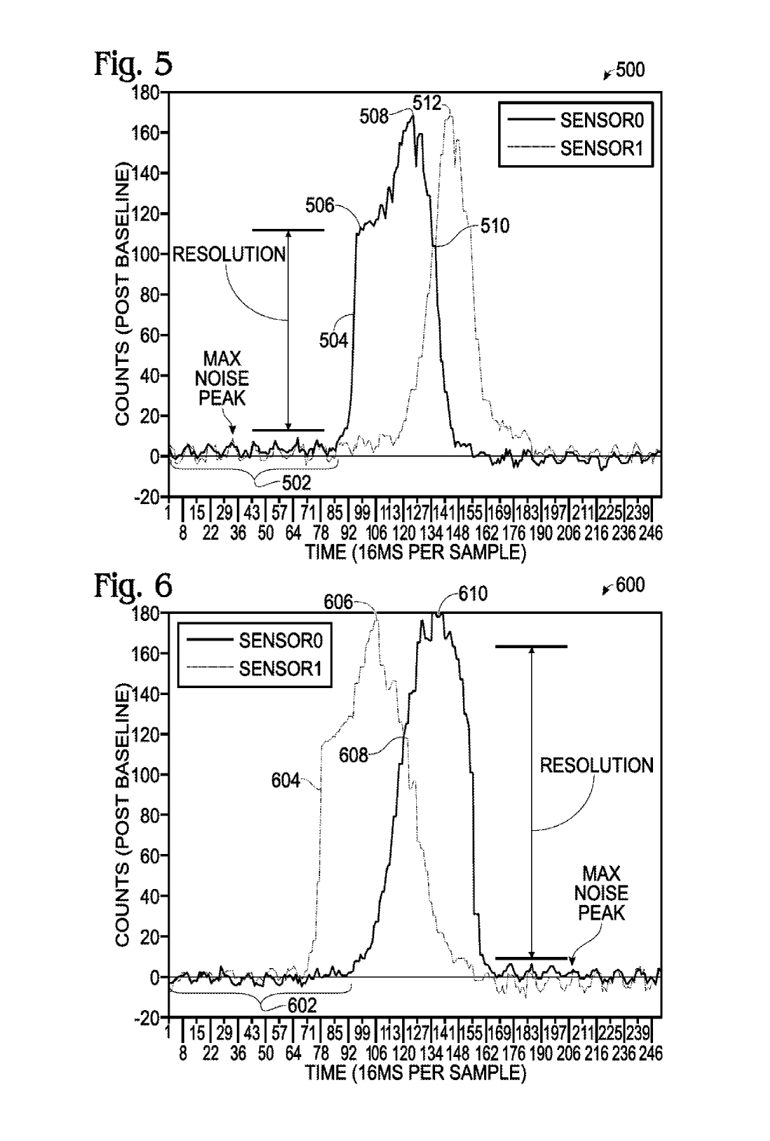

FIG. 5 shows a graph 500 illustrating outputs from sensor0 and sensor1 in the form of an inverse count (e.g. a maximum number of counts per sample minus a detected number of counts) as a function of time during a “swipe up” thumb gesture (e.g. with reference to the orientation of sensor 100 in FIG. 1). First, graph 500 shows an initial period of noise 502, followed by a detection of touch at sensor0 at 504. Upon detection of touch, the sensor0 output rises quickly to a shoulder 506 corresponding to a close proximity of the user's thumb to the sensor, and then rises to a full peak 508 that represents a thumb touching the sensor. Thus, it can be seen that a resolution of touch sensor 102 to a touch or a near touch is far above the average noise level. Graph 500 also shows a crossover 510 at which the sensor0 signal falls below the sensor1 signal. After the crossover 510, the sensor1 signal rises to a peak 512, and then falls back to the noise level, representing movement of the user's thumb off of sensor1, as in the case of example gesture 420 of FIG. 4.

FIG. 6 shows a graph 600 illustrating outputs from sensor0 and sensor1 in the form of an inverse count (e.g. a baseline number of counts per sample minus a detected number of counts) as a function of time during a “swipe down” thumb gesture (e.g. with reference to the orientation of sensor 100 in FIG. 1). First, graph 600 shows an initial period of noise 602, followed by a detection of touch at sensor1 at 604. Upon detection of touch, the sensor0 output rises to a peak 606, and then falls to a crossover 608 at which the falling sensor0 signal falls below the rising sensor1 signal. After the crossover 608, the sensor1 signal rises to a peak 610, and then falls back to the noise level when sensor1 is no longer touched.

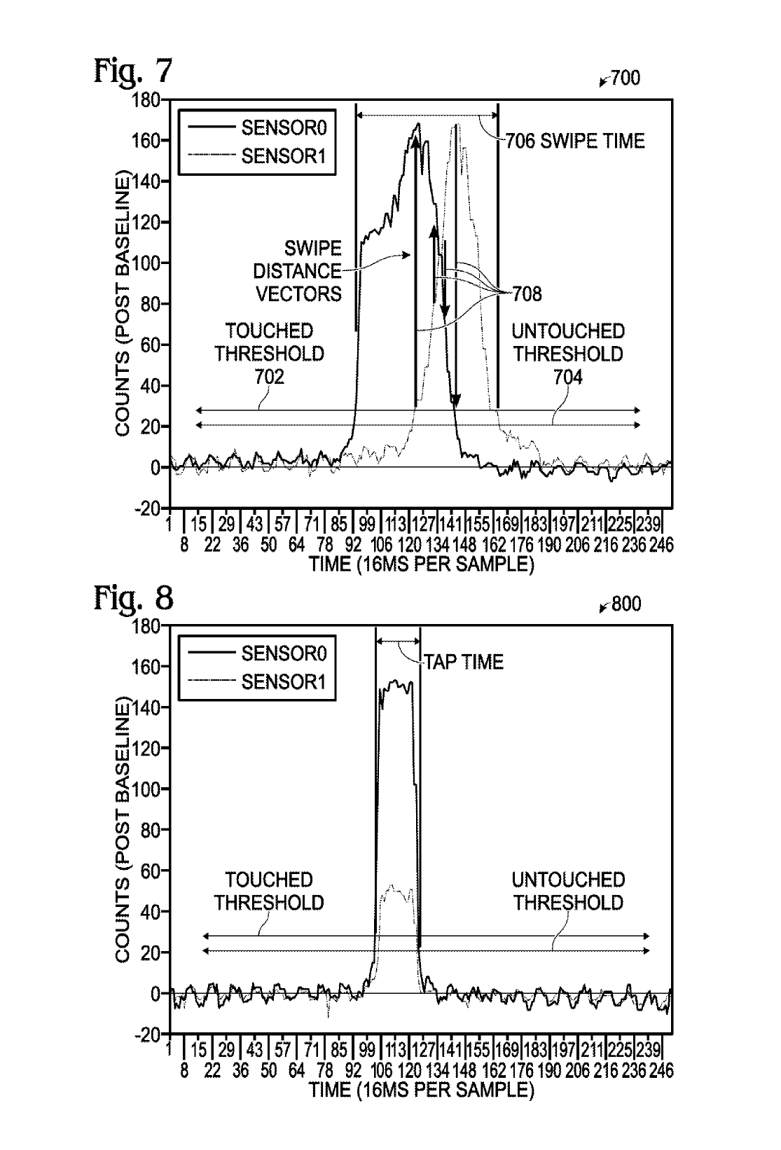

FIG. 7 shows a graph 700 that illustrates non-limiting example parameters that may be considered when analyzing the output of sensor0 and sensor1 for a touch input. For example, FIG. 7 illustrates a touched threshold count 702 and an untouched threshold count 704, which respectively illustrate thresholds that, when passed, signify a change between touched and untouched states. It will be noted that the use of two thresholds allows for some hysteresis, which may allow for smoother and more stable transitions between touched and untouched states than the use of a single threshold.

FIG. 7 also illustrates a swipe time parameter 706, which is shown as corresponding to a time between an untouched-to-touched transition and a touched-to-untouched transition for both touch sensing capacitors together. Additionally, FIG. 7 illustrates swipe distance vectors 708, which represents a distance from the interface between the two sensors (such that, as the vector grows from the crossover, the finger moves away from the crossing point). It will be understood that these particular parameters are shown for the purpose of example, and that any suitable parameter or set of parameters may be considered when analyzing touch data for swipe inputs.

In some embodiments, more than one gesture may be detected by a touch sensor. For example, touch sensor 102 may be configured to detect both swipe and tap inputs. In this case, rules also may specify an order of priority for gestures. As one non-limiting example, touch sensor 102 may give swipe gestures a higher priority than tap gestures. In such an embodiment, rules may specify that a tap gesture is reported if swipe criteria are not met, and then tap criteria are met. Thus, in this example, the sensor data is not analyzed for a tap input unless swipe criteria are not met. It will be understood that tap inputs may be assigned a higher priority in some embodiments, and that any set of allowed gesture inputs may be given any suitable priority order. Further, in some embodiments, a system may analyze multiple possible gestures and assign a confidence value to each, rather than utilizing a priority order.

As with swipe gestures, any suitable rules may be used to identify tap gestures. FIG. 8 shows a graph 800 illustrating example parameters that may be considered in a tap input analysis. For example, a tap input may be identified by a minimum and/or maximum time for performance of the gesture, as illustrated by a time that one or both signals exceed a “touched” threshold, combined with the absence of factors (e.g. crossover) used to identify swipe gestures.

Upon identifying a touch gesture, such as a swipe or tap, a human interface device may provide any suitable output to a computing device. For example, in some embodiments, specific gestures may be mapped to specific operating system or application interactions. As a more specific example, some operating systems, such as the WINDOWS 8 operating system and versions thereof, may utilize horizontal touch gestures on a touch-sensitive display to interact with the operating system (e.g. change between application views, reveal menus, etc.). Thus, in some embodiments, thumb swipe gestures may be mapped to such interactions. Further, the human interface device may be configured to provide an output to the computing device that is recognizable by the computing device as representing a specific gesture, without having to install any associated logic on the computing device to understand the human interface device output. As one non-limiting example, the human interface device may provide an output recognizable by a host computing device as a specific keystroke or combination of keystrokes from a keyboard that are configured to invoke the interaction.

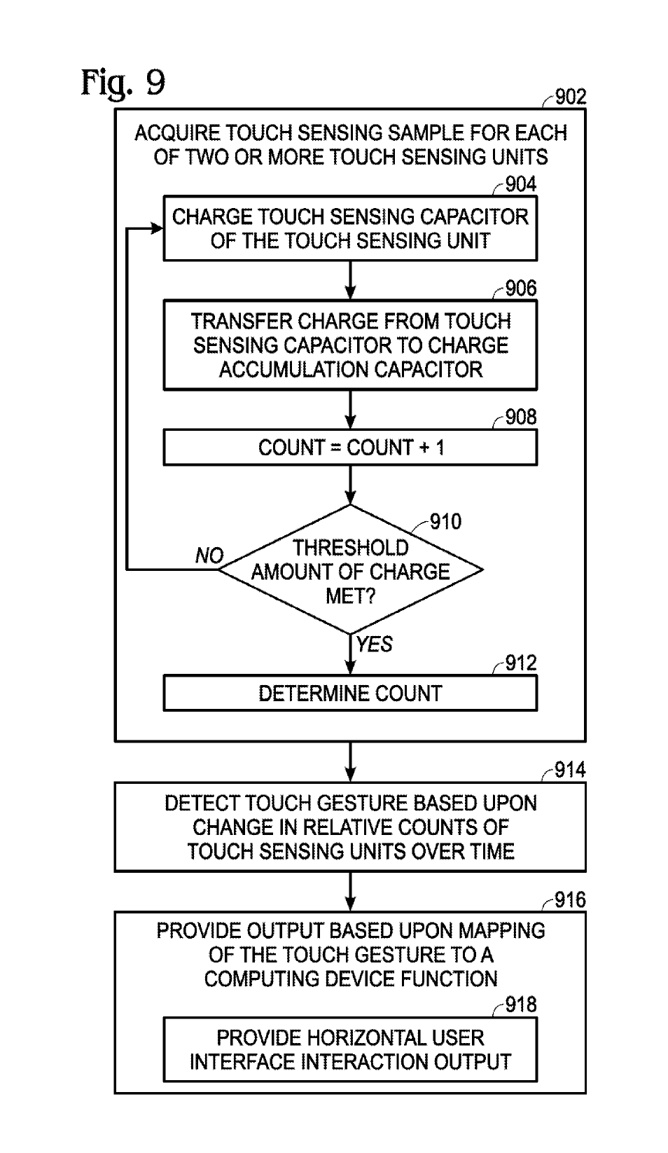

FIG. 9 shows a flow diagram depicting an embodiment of a method 900 for operating a touch sensor, such as touch sensor 102. Method 900 comprises, at 902, acquiring a touch sensing sample for each of two or more touch sensing units. The touch sensing samples for each touch sensing unit may be acquired in any suitable manner. For example, acquiring a touch sensing sample for each touch sensing unit may comprise charging a touch-sensing capacitor of each touch sensing unit at 904, transferring charge from the touch sensing capacitor to a charge accumulation capacitor for the touch-sensing unit at 906, and increasing a counter at 908. Then, the charge on the charge accumulation capacitor may be compared to a threshold at 910. If a threshold charge is not met, then the touch sensing capacitor may again be charged and discharged. On the other hand, if the charge threshold is met, then the total count may be determined at 912. As the capacitance of the touch sensing capacitor will increase when touched, the count will be lower in the presence of a touch than in the absence of a touch. Non-limiting implementations of these processes are described in more detail above with reference to FIG. 3.

The acquisition of touch sensor samples at 902 may be performed on a periodic basis, and may be performed at any suitable frequency. Suitable frequencies include, but are not limited to, frequencies of 30 Hz and higher.

Upon collecting touch sensor samples, method 900 comprises, at 914, detecting a touch gesture based upon a change in the touch sensor outputs over time. For example, in the above-described embodiments, changes in counts over time may be used to detect touch gestures. Any suitable changes in sensor outputs over time may be used to detect touch gestures, depending upon the gestures to be detected and/or a layout of sensor elements used. It will be understood that the examples described above with regard to FIGS. 4-8 are shown as examples of gestures that may be detected with a touch sensor comprising two touch sensing units, and are not meant to be limiting in any manner.

Method 900 further comprises, at 916, providing an output based upon a mapping of the touch gesture to a computing device function. It will be understood that a touch gesture may be mapped to any suitable computing device function, including but not limited to application-specific functions as well as operating system functions. Further, the output may be configured to be utilizable by a host computing device without the installation of any corresponding logic on the host computing device. For example, in some embodiments, an output may be configured to be recognizable as a specific keystroke or combination of keystrokes ordinarily performed via a keyboard. In other embodiments, an output may be mapped to a different gesture than that performed. As one more specific example, a thumb swipe gesture may be mapped to a horizontal user interface command (e.g. to reveal a menu bar, to change application windows, etc.).

While described herein in the context of a computer mouse, it will be understood that a touch sensor according to the present disclosure may be used with any suitable human interface device for a computing device, including but not limited to touch screens, track pads, keyboards, game controllers, wearable computing devices (e.g. wrist computing devices, head-mounted computing devices), interface sensors located on a smartphone, tablet, netbook, pocket PC, remote controls, set-top boxes, etc., The use of a relatively small number of touch sensing capacitors may allow larger touch sensing capacitors to be used than a grid-style touch sensor. Likewise, the use of multiple cycles of charging a touch sensing capacitor and then transferring the charge to a charge accumulation capacitor may help to achieve relatively high signal to noise ratios compared to the use of grid-style touch sensors.

In some embodiments, the methods and processes described herein may be tied to a computing system of one or more computing devices. In particular, such methods and processes may be implemented as a computer-application program or service, an application-programming interface (API), a library, and/or other computer-program product.

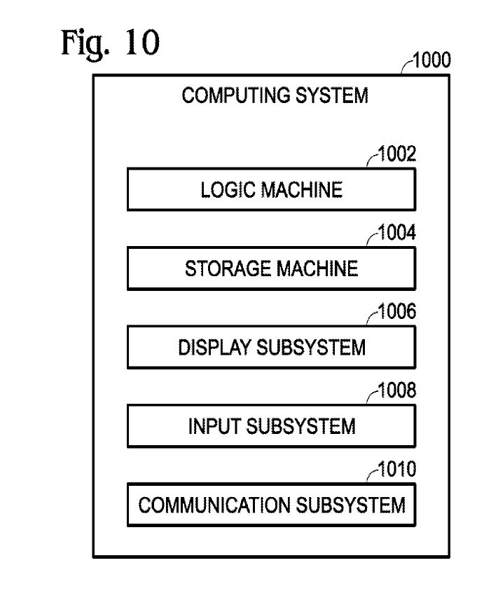

FIG. 10 schematically shows a non-limiting embodiment of a computing system 1000 that can enact one or more of the methods and processes described above. Computing system 1000 is shown in simplified form. Computing system 1000 may take the form of one or more personal computers, server computers, tablet computers, home-entertainment computers, network computing devices, gaming devices, mobile computing devices, mobile communication devices (e.g., smart phone), wearable computing devices, human interface devices, and/or other computing devices, including but not limited to the computing devices and human interface devices disclosed herein.

Computing system 1000 includes a logic machine 1002 and a storage machine 1004. Computing system 1000 may optionally include a display subsystem 1006, input subsystem 1008, communication subsystem 1010, and/or other components not shown in FIG. 10.

Logic machine 1002 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 1004 includes one or more physical devices configured to hold instructions executable by the logic machine to implement the methods and processes described herein. When such methods and processes are implemented, the state of storage machine 1004 may be transformed—e.g., to hold different data.

Storage machine 1004 may include removable and/or built-in devices. Storage machine 1004 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 1004 may include volatile, nonvolatile, dynamic, static, read/write, read-only, random-access, sequential-access, location-addressable, file-addressable, and/or content-addressable devices. Storage machine 1004 and logic machine 1002 may in some embodiments be incorporated in controller on a human interface device.

It will be appreciated that storage machine 1004 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 1002 and storage machine 1004 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The term “program” may be used to describe an aspect of computing system 1000 implemented to perform a particular function. In some cases, a program may be instantiated via logic machine 1002 executing instructions held by storage machine 1004. It will be understood that different programs may be instantiated from the same application, service, code block, object, library, routine, API, function, etc. Likewise, the same program may be instantiated by different applications, services, code blocks, objects, routines, APIs, functions, etc. The term program may encompass individual or groups of executable files, data files, libraries, drivers, scripts, database records, etc.

When included, display subsystem 1006 may be used to present a visual representation of data held by storage machine 1004. This visual representation may take the form of a graphical user interface (GUI) with which a user may interact via a human interface device. As the herein described methods and processes change the data held by the storage machine, and thus transform the state of the storage machine, the state of display subsystem 1006 may likewise be transformed to visually represent changes in the underlying data. Display subsystem 1006 may include one or more display devices utilizing virtually any type of technology. Such display devices may be combined with logic machine 1002 and/or storage machine 1004 in a shared enclosure, or such display devices may be peripheral display devices.

Input subsystem 1008 may comprise or interface with one or more user-input devices such as a keyboard, game controller, mouse, touch sensor, button, optical position tracker, etc. In some embodiments, the input subsystem may comprise or interface with selected natural user input (NUI) componentry. Such componentry may be integrated or peripheral, and the transduction and/or processing of input actions may be handled on- or off-board.

Communication subsystem 1010 may be configured to communicatively couple computing system 1000 with one or more other computing devices (e.g. to communicatively couple a human interface device to a host computing device). Communication subsystem 1010 may include wired and/or wireless communication devices compatible with one or more different communication protocols.

It will be understood that the configurations and/or approaches described herein are presented for the purpose of example, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A human interface device, comprising:
a touch sensor comprising two or more touch sensing units, each touch sensing unit comprising a touch sensing pad and a charge accumulation capacitor in communication with the touch sensing pad; and
a controller in communication with each touch sensing unit, the controller being configured to
acquire a sample from each touch sensing unit by iteratively charging the touch sensing pad of the touch sensing unit and transferring charge from the touch sensing pad of the touch sensing unit to the charge accumulation capacitor of the touch sensing unit, and
detect a touch gesture based upon the touch sensing samples for the two or more touch sensing units and based upon a threshold.

2. The human interface device of claim 1, wherein the human interface device comprises a computer mouse.

3. The human interface device of claim 2, wherein each touch sensing pad is located on a thumb side of the computer mouse.

4. The human interface device of claim 3, wherein the touch sensor comprises a first touch sensing pad and a second touch sensing pad located on the thumb side of the computer mouse.

5. The human interface device of claim 1, wherein the threshold comprises a threshold amount of charge.

6. The human interface device of claim 5, wherein the threshold amount of charge comprises an amount of charge that meets a logic threshold of the controller.

7. The human interface device of claim 5, wherein the controller is configured to determine the touch state by determining a count taken to reach the threshold amount of charge.

8. The human interface device of claim 1, wherein the controller is further configured to detect the touch gesture based upon a change in a touch state a first touch sensing unit relative to a touch state of a second touch sensing unit over time.

9. The human interface device of claim 8, wherein the controller is further configured to determine a mapping of the touch gesture to a computing device function, and provide an output based upon the computing device function.

10. The human interface device of claim 1, wherein the threshold comprises a threshold number of cycles, and wherein the controller is configured to determine a touch state by determining a discharge time for the charge accumulation capacitor.

11. The human interface device of claim 1, wherein, for each touch sensing unit, the charge accumulation capacitor is connected to a first pin and a second pin of the controller and the touch sensing pad is connected via a resistor to the first pin and the charge accumulation capacitor, and
wherein the controller is configured to acquire the touch sensing sample by iteratively
setting the first pin and the second pin to logic high to charge the touch sensing pad,
setting the second pin to logic low while setting the first pin to logic high to transfer charge from the touch sensing pad to the charge accumulation sensor,
increasing a counter, and
setting the first pin to logic low and setting the second pin to an input mode to read the charge on the charge accumulation capacitor.

12. The human interface device of claim 1, wherein the controller is further configured to determine a mapping of the touch gesture to a computing device function, and provide an output based upon the mapping.

13. A computer mouse, comprising:
a body;
a thumb gesture touch sensor disposed on a thumb side of the body, the thumb gesture touch sensor comprising a touch sensor having two or more touch sensing units, each touch sensing unit comprising a touch sensing pad and a charge accumulation capacitor; and
a controller in communication with each touch sensing unit, the controller being configured to
acquire a touch sensing sample from each touch sensing unit by iteratively charging the touch sensing pad of the touch sensing unit and transferring charge from the touch sensing pad of the touch sensing unit to the charge accumulation capacitor of the touch sensing unit until a threshold amount of charge has been met,
determine a count of iterations performed for the touch sensing unit during acquisition of the sample, and
detecting a touch gesture based upon the count determined for each touch sensing unit.

14. The computer mouse of claim 13, wherein the threshold amount of charge comprises an amount of charge that meets a logic threshold of the controller.

15. The computer mouse of claim 13, wherein the controller is further configured to provide an output based upon a mapping of the touch gesture to a computing device function.

16. The computer mouse of claim 13, wherein the output is configured to be recognizable by a host computing device as one or more keystrokes.

17. The computer mouse of claim 13, wherein, for each touch sensing unit, the charge accumulation capacitor is connected to a first pin and a second pin of the controller and the touch sensing pad is connected to the first pin and the charge accumulation capacitor via a resistor, and
wherein the controller is configured to acquire the touch sensing sample by iteratively setting the first pin and the second pin to logic high to charge the touch sensing pad, setting the second pin to logic low while setting the first pin to logic high to transfer charge from the touch sensing pad to the charge accumulation sensor, increasing a counter, and setting the first pin to logic low and setting the second pin to an input mode to read the charge on the charge accumulation capacitor.

18. On a human interface device, a method of detecting a touch gesture, the human interface device comprising a controller in communication with each of two or more touch sensing units, each touch sensing unit comprising a touch sensing pad and a charge accumulation capacitor, the charge accumulation capacitor having a larger capacitance than the touch sensing pad, the method comprising:
acquiring a touch sensing sample from each touch sensing unit by iteratively charging the touch sensing pad of the touch sensing unit and transferring charge from the touch sensing pad of the touch sensing unit to the charge accumulation capacitor of the touch sensing unit until a threshold amount of charge has been met;
determine a count of iterations performed for each touch sensing unit during acquisition of the sample;
detecting a touch gesture based upon the count for each touch sensing unit; and
providing an output based upon a mapping of the touch gesture to a computing device function.

19. The method of claim 18, further comprising detecting a touch gesture based upon a change in a count from a first touch sensing unit relative to a count from a second touch sensing unit over time.

20. The method of claim 18, wherein, for each touch sensing unit, the charge accumulation capacitor is connected to a first pin and a second pin of the controller and the touch sensing pad is connected to the first pin and the charge accumulation capacitor via a resistor, and wherein acquiring a touch sensing sample comprises:
setting the first pin and the second pin to logic high to charge the touch sensing pad,
setting the second pin to logic low while setting the first pin to logic high to transfer charge from the touch sensing pad to the charge accumulation sensor,
increasing a counter,
setting the first pin to logic low and setting the second pin to an input mode to read the charge on the charge accumulation capacitor, and comparing the charge to a threshold.
